(19) United States
(12) Patent Application Publication
(10) Pub. No.: US 2026/0056098 A1
(43) Pub. Date: Feb. 26, 2026

(54) TEMPERATURE CONTROLLED BALLAST TESTING SYSTEM AND METHOD

(71) Applicant: University of South Carolina, Columbia, SC (US)

(72) Inventors: Yu Qian, Irmo, SC (US); Shihao Huang, Stephenville, TX (US)

(21) Appl. No.: 19/309,797

(22) Filed: Aug. 26, 2025

Related U.S. Application Data
(60) Provisional application No. 63/686,924, filed on Aug. 26, 2024.
(60) Provisional application No. 63/709,594, filed on Oct. 21, 2024.

(51) Int. Cl. G01N 1/42; F25D 17/02; G01N 1/28

(52) U.S. Cl. CPC G01N 1/42; F25D 17/02; G01N 1/286

(57) ABSTRACT

A freezing system for preparing a frozen ballast layer sample is provided. A method of preparing a frozen ballast sample via the freezing system is also provided. The freezing system includes a cylindrical mold; a cooling blanket; at least one layer of a thermal isolation material; and a chiller unit. Further, the freezing system is configured to freeze a compacted ballast layer sample to a temperature ranging from about −10° C. to about −20° C. to form the frozen ballast layer sample. The frozen ballast layer sample can then be subjected to load testing to determine its mechanical properties under simulated progressive thawing conditions.

### CROSS-REFERENCE TO RELATED APPLICATIONS

The present application claims priority to U.S. Provisional Patent Application No. 63/686,924, filed Aug. 26, 2024, and U.S. Provisional Patent Application No. 63/709,594, filed Oct. 21, 2024, the entire contents of which are incorporated herein by reference.

### TECHNICAL FIELD

The subject matter disclosed herein is generally directed to a system and method for testing railroad ballast samples under various controlled temperature conditions.

### BACKGROUND

In the context of railroad systems, ballasted track is composed of uniformly graded coarse aggregates with high drainage performance. Ballasted track is widely used for freight and heavy-haul railroads worldwide. The ballast layer primarily functions to transfer train loading the subgrade, facilitate drainage, and maintain track geometry and stability. As a typical granular material, ballast aggregate exhibits permanent deformation (settlement) under cyclic loading, resulting from particle rotational and translational movements. Excessive settlement of the ballasted track initially degrades rail geometry and can further lead to train derailment, causing property loss and even fatalities.

Existing research on the permanent deformation of railroad track ballast mainly focuses on dry testing conditions, despite railway infrastructure being widely constructed in permafrost and seasonally frozen regions. Besides the dry scenario, ballasted track can also become wet due to rainfall or underground water. Although clean/new ballast material is conventionally considered to have low water retention capacity, the flowing surface water in ballast during rainy weather can significantly increase ballast deformation. Under long-term train operation, the newly constructed ballast layer gradually becomes fouled due to aggregate breakdown and the intrusion of fouling materials such as sand or clay, which can greatly increase its water-holding capacity. Degraded/fouled ballast under wet conditions has been found to exhibit significantly larger permanent deformation and reduced shear strength compared to dry testing conditions. Fouled ballast under progressive wetting conditions resulting from varying rainfall intensities and durations also influences the development pattern of permanent deformation. Moreover, different climatic conditions can cause the railroad track to fluctuate between saturated and unsaturated conditions.

Most research on the permanent deformation of ballast has been limited to dry and wet conditions, while railway infrastructure is widely distributed in both permafrost regions (such as the Qinghai-Tibet Plateau in China and northern Manitoba in Canada) and seasonally frozen regions (such as the northeastern United States and northern Finland). Taking the Qinghai-Tibet Plateau as an example, studies indicate that its average air temperature, affected by global warming, increased by 0.6° C. to 1.6° C. from 1996 to 2006, and it is predicted to increase by about 2.2° C. to 2.6° C. by 2050. For the Qinghai-Tibet Railway built on it, the effect of global warming would increase the active thickness of the railway substructure through permafrost degradation, which greatly challenges its regular maintenance. In seasonally frozen areas, ice forms inside the railroad bed during Fall and Winter and thaws in the Spring and Summer. Whether due to permafrost degradation induced by global warming or ice thawing in seasonally frozen regions, there is a coupled effect of repeated train loading and progressive ice thawing exerted on the mechanical performance of the railroad track.

Currently, few systems investigate the effect of ice thawing on the deformation behaviors of frozen ballast, and how the permanent deformation of frozen ballast develops under progressive thawing conditions remains unclear. Moreover, most systems focus on testing of small granular systems such as clay or sand rather than the larger aggregate materials that make up railroad ballast.

As such, a need currently exists for a system and method of testing railroad ballast in a laboratory, research, or field conditions, where such systems and methods account for variations in temperature to which the ballast is subjected over time. Further, a system and method that does not require the use of a temperature controlled room would be useful.

### SUMMARY

Aspects and advantages of embodiments of the present disclosure will be set forth in part in the following description, or can be learned from the description, or can be learned through practice of the embodiments.

In one aspect of the present disclosure, a freezing system for preparing a frozen ballast layer sample is provided. The freezing system includes a cylindrical mold; a cooling blanket; at least one layer of a thermal isolation material; and a chiller unit, wherein the freezing system is configured to freeze a compacted ballast layer sample to a temperature ranging from about −10° C. to about −20° C.

In another aspect, the freezing system can include a compaction machine, wherein the compaction machine can be configured to compact the compacted ballast layer sample to a void ratio ranging from about 0.55 to about 0.75.

In still another aspect, the freezing system can include at least one membrane wrapped around the cylindrical mold, wherein the at least one membrane can have a thickness ranging from about 0.65 millimeters to about 0.85 millimeters and a tensile strength ranging from about 20 megapascals to about 35 megapascals. Further, the at least one membrane can include rubber. In addition, the at least one membrane can include two membranes.

In yet another aspect, the freezing system can include water, wherein the compacted ballast layer sample can be saturated with water prior to freezing.

In an additional aspect, the cooling blanket can be filled with a thermal transfer fluid having a freezing point of less than about −20° C. Further, the thermal transfer fluid can include a mixture of ethylene glycol and water. Additionally, the chiller unit can be connected to the cooling blanket via a tube.

In one more aspect, the thermal transfer fluid can be circulated through the cooling blanket via the chiller unit to create a flow cycle to decrease the temperature of the cooling blanket to a temperature ranging from about −10° C. to about −20° C.

In another aspect, the at least one layer of the thermal isolation material can be wrapped around the cooling blanket.

In one more aspect of the present disclosure, a method for preparing frozen ballast samples using a freezing system comprising a cylindrical mold, a cooling blanket, at least one layer of a thermal isolation material, and a chiller unit is provided. The method includes obtaining a ballast layer sample; depositing the ballast layer sample into the cylindrical mold; saturating the ballast layer sample with water; attaching the cooling blanket to the cylindrical mold; wrapping the cooling blanket with the at least one layer of the thermal isolation material; and activating the chiller unit to circulate a thermal transfer fluid throughout the cooling blanket, wherein the ballast layer sample is frozen to a temperature ranging from about −10° C. to about −20° C.

In a further aspect, the method can include compacting the ballast layer sample a compaction machine to a void ratio ranging from about 0.55 to about 0.75 prior to saturating the ballast layer sample with water to form a compacted ballast layer sample.

In yet another aspect, the method can include wrapping the cylindrical mold in at least one membrane, wherein the at least one membrane has a thickness ranging from about 0.65 millimeters to about 0.85 millimeters and a tensile strength ranging from about 20 megapascals to about 35 megapascals. Further, the at least one membrane can include rubber. Further still, the at least one membrane can include two membranes.

In still another aspect, the thermal transfer fluid can have a freezing point of less than about −20° C.

In an additional aspect, the thermal transfer fluid can include a mixture of ethylene glycol and water.

In another aspect, the chiller unit can be connected to the cooling blanket via a tube.

In one more aspect, the thermal transfer fluid can be circulated through the cooling blanket via the chiller unit for a time period ranging from about 12 hours to about 60 hours.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling disclosure of the present disclosure to one skilled in the art, including the best mode thereof, is set forth more particularly in the remainder of the specification, including reference to the accompanying figures, in which:

FIG. 1A illustrates a stable ballast layer;

FIG. 1B illustrates a ballast layer under rainfall conditions with water seepage present;

FIG. 1C illustrates a ballast layer experiencing mud pumping;

FIG. 1D illustrates ice formation on the surface of a ballast layer;

FIG. 1E illustrates the expansion of a ballast layer due to ice;

FIG. 1F illustrates an unstable ballast layer after ice melting or mud pumping;

FIG. 2A illustrates train loading of a dry ballast layer;

FIG. 2B illustrates train loading of a frozen ballast layer in a permafrost region;

FIG. 2C illustrates train loading of a ballast layer undergoing ice thawing due to warming;

FIG. 3 is a graph illustrating the particle size distribution of tested ballast material according to one example of the present disclosure;

FIG. 4A illustrates a top perspective view of a ballast testing system according to one aspect of the present disclosure;

FIG. 4B illustrates a side view of a ballast testing system according to one aspect of the present disclosure;

FIG. 4C illustrates a top perspective view of a ballast testing system according to one aspect of the present disclosure;

FIG. 4D illustrates a side view of a ballast testing system according to one aspect of the present disclosure;

FIG. 5A illustrates a top perspective view of a ballast testing system according to one aspect of the present disclosure when in use;

FIG. 5B illustrates a top perspective view of a frozen ballast layer sample prepared using the ballast testing system according to one aspect of the present disclosure;

FIG. 5C illustrates a side view of a frozen ballast prepared using the ballast testing system according to one aspect of the present disclosure;

FIG. 5D illustrates a perspective view of a sealed frozen ballast layer sample prepared using the ballast testing system according to one aspect of the present disclosure;

FIG. 6 illustrates a ballast layer sample prepared using the ballast testing system placed inside a triaxial loading frame;

FIG. 7 is a graph illustrating the cyclic loading conditions of the ballast layer sample when undergoing testing;

FIG. 8 is a graph illustrating the ice content of the ballast layer sample based on testing time;

FIG. 9 is a graph comparing the shear stress of new and degraded ballast layer samples when tested under monotonic loading;

FIG. 10A is a graph illustrating the definition of secant modulus;

FIG. 10B is a bar graph illustrating the secant modulus for a degraded ballast layer sample and a new ballast layer sample;

FIG. 11 is a graph comparing the permanent deformation of new and degraded ballast layer samples under dry conditions;

FIG. 12A is a graph illustrating the permanent deformation of degraded frozen ballast layer samples under progressive thawing conditions;

FIG. 12B is a graph illustrating the permanent deformation of new frozen ballast layer samples under progressive thawing conditions;

FIG. 13A is a graph illustrating the relationship between permanent deformation and pore ice content of degraded frozen ballast layer samples under progressive thawing conditions;

FIG. 13B is a graph illustrating the relationship between permanent deformation and pore ice content of new frozen ballast layer samples under progressive thawing conditions;

FIG. 14A is a graph illustrating the effect of progressive thawing on permanent deformation compared with dry conditions for a new ballast layer sample; and

FIG. 14B is a graph illustrating the effect of progressive thawing on permanent deformation compared with dry conditions for a degraded ballast layer sample.

Repeat use of reference characters in the present specification and drawings is intended to represent the same or analogous features or elements of the present disclosure.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present disclosure. Any of the features, components, or details of any of the arrangements or embodiments disclosed in this application are interchangeably combinable with any other features, components, or details of any of the arrangements or embodiments disclosed herein to form new arrangements and embodiments.

Generally speaking, the present disclosure is directed to a system and method that examines the permanent deformation of frozen new and degraded ballast under cyclic loading and progressive thawing conditions. The results indicate that even though frozen ballast is bonded with ice, its deformation under progressive thawing conditions is higher compared to dry testing conditions. Frozen degraded ballast is found to exhibit a distinct deformation pattern from frozen new ballast. Furthermore, the sensitivity of permanent deformation of frozen ballast to progressive thawing conditions is dependent on ballast degradation, with degraded ballast being more sensitive than new ballast. These findings and the resulting system and method to prepare ballast samples that mimic real-world environmental conditions provide crucial insights into the deformation behaviors of frozen ballast and offer guidance for railroad maintenance in cold regions.

Specifically, instead of using a temperature-controlled room to prepare frozen aggregate ballast testing specimens, the freezing system and method of the present disclosure involves wrapping a ballast layer sample preparation mold (e.g., a cylindrical mold) with a cooling blanket and sealing it with one or more layers of a thermal isolation material. A chiller unit can then be used to circulate fluid, which freezes the ballast layer sample for testing under controlled conditions, which will be discussed in more detail below. Without intending to be limited by any particular theory, the present inventors have found that system and method of the present disclosure enable for the preparation of frozen ballast layer samples that can be subjected to degradation and/or temperature fluctuations as would a ballast in the natural environment to investigate the impact of heterogeneous moisture distribution and ice formation in the ballast layer of a railroad track, which improves the accuracy of testing. This, in turn, leads to better predictions regarding maintenance and potential failure of ballast, which can ultimately provide data useful in developing solutions that can improve the safety of the world's railroad systems.

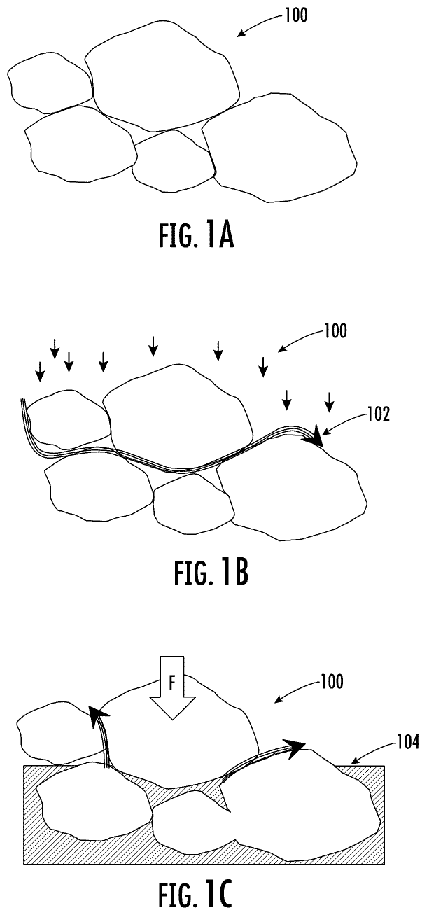

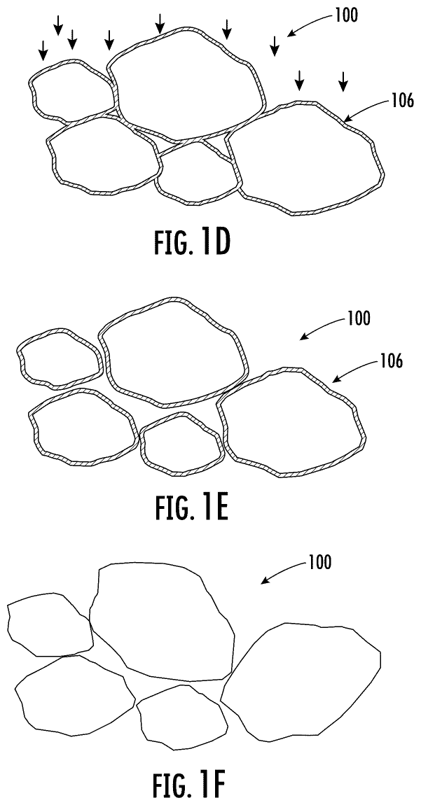

Referring now to the figures, the particular components of the freezing system and method contemplated by the present disclosure and concepts related thereto are discussed in more detail. Specifically, FIGS. 1A-1E illustrate a ballast layer under various environmental conditions and demonstrate that the ballast layer of a track substructure is inherently composed of aggregate and fouling materials that accumulate varying amounts of moisture and that it should not be thought of or tested under the assumption that it is a homogeneous and dry layer. Rather, the ballast layer is a heterogeneous structure with varying amounts of moisture, where fine particle migration can alter the grain size distribution and drainage seepage pattern, particularly under extreme weather conditions such as freeze/thaw patterns. In particular, FIG. 1A illustrates a stable ballast layer 100; FIG. 1B illustrates a ballast layer 100 under rainfall conditions with water seepage present due to the presence of rainwater 102; FIG. 1C illustrates a ballast layer 100 experiencing mud pumping due to mud 104; FIG. 1D illustrates the formation of ice 106 on the surface of a ballast layer 100; FIG. 1E illustrates the expansion of a ballast layer 100 due to ice 106; and FIG. 1F illustrates an unstable ballast layer 100 after ice melting or mud pumping, where the various components of the ballast layer 100 have shifted into unstable positions after thawing.

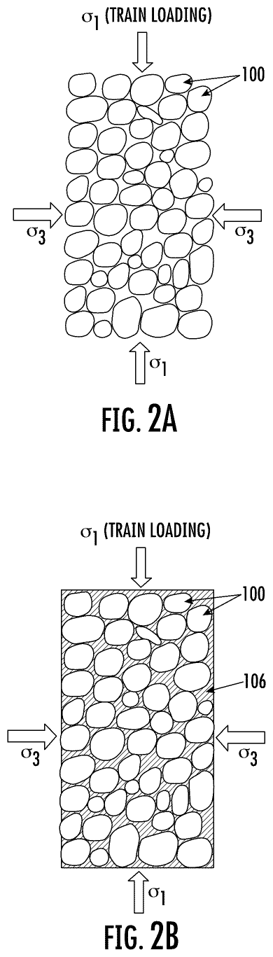

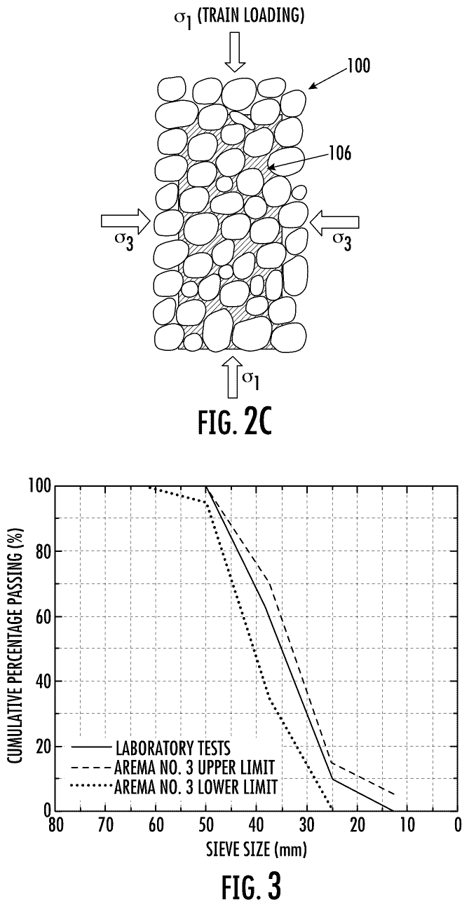

Turning now to FIGS. 2A-2C, the mechanics behind the permanent deformation characteristics of a ballast layer 100 under progressive thawing conditions are illustrated. Under dry conditions as shown in FIG. 2A, the ballast layer 100 is composed of discrete granular materials, and its deformation characteristics under cyclic loading are generally known. In frozen conditions as shown in FIG. 2B, discrete particles in the ballast layer 100 are bonded together by ice, and their deformation could be different even under the same train loading. Due to global warming and seasonal effects, progressive ice thawing would occur inside the ballasted track in permafrost regions, causing more ice bonds to melt and leaving more ballast particles discrete, as shown in FIG. 2C. Under repeated train loading, the progressive alteration of decreasing ice bonds and increasing discrete ballast particles on permanent deformation is an unexplored research field that interests railroad engineers. Additionally, it is expected that the particle morphology of railroad ballast would experience degradation under long-term train loading, exhibiting reduced angularity and increased roundness. Although the role of particle shape on the deformation behavior of ballast has been revealed under dry conditions, as discussed above, its impact on ballast permanent deformation under progressive thawing conditions remains unknown and is the subject of the present disclosure.

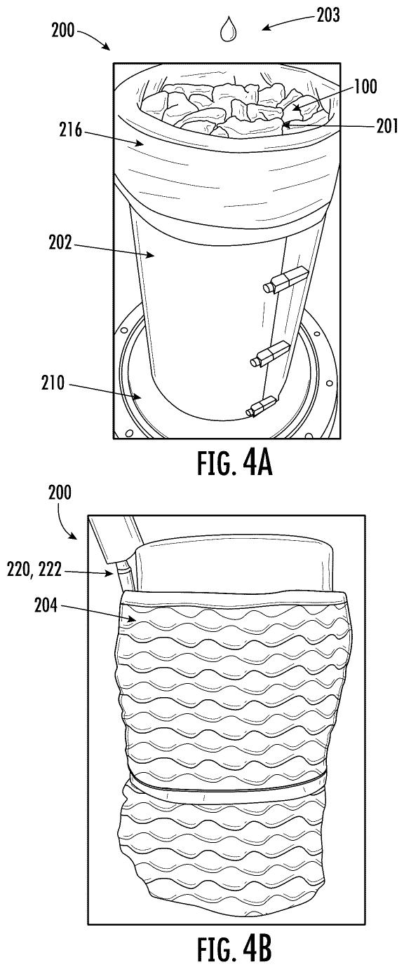

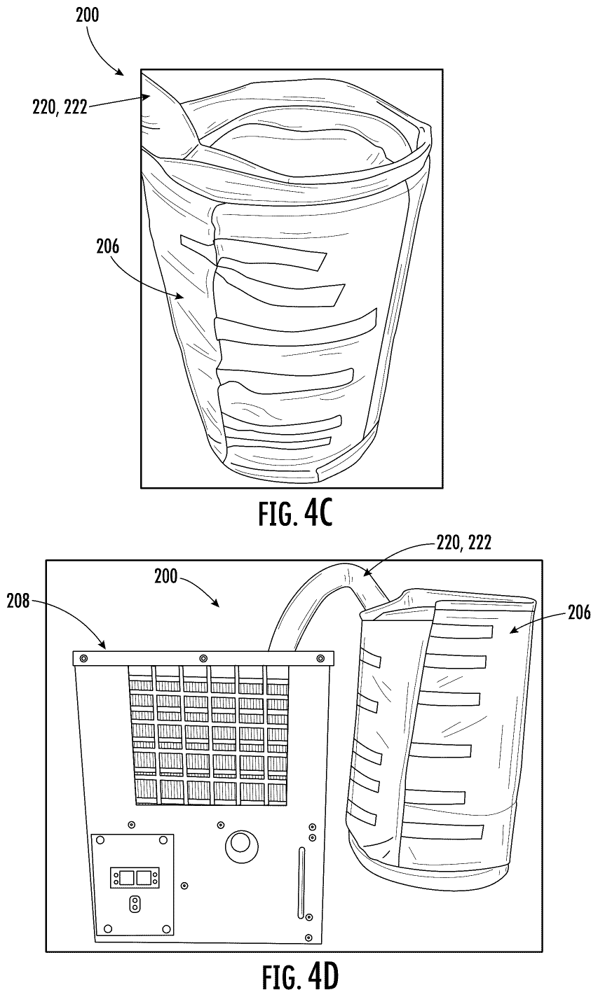

As such, the present disclosure is directed to systems and methods to investigate the aforementioned effect of progressive thawing conditions on the permanent deformation of new and degraded ballast aggregates through large-scale triaxial testing. First, new ballast aggregates are directly collected from the U.S. Class I railroad revenue track, and degraded ballast particles are recycled from the laboratory after a series of preliminary triaxial cyclic and monotonic tests. Then, referring to FIGS. 4A, 4B, 4C, 4D, 5A, 5B, 50, 5D, and 6, frozen ballast layer samples 100 composed of new and degraded ballast aggregates are prepared separately using a newly developed freezing system 200, with dimensions suitable for large scale triaxial testing. Finally, a series of triaxial cyclic tests are conducted under coupled cyclic loading and progressive thawing conditions using a triaxial testing frame 300. Specifically, the freezing system 200 includes a cylindrical mold 202, a cooling blanket 204, a thermal isolation material 206, and a chiller unit 208 that is capable of freezing the ballast layer sample 100 to a temperature ranging from about −10° C. to about −20° C., such as from about −12° C. to about −18° C., such as from about −14° C. to about −16° C. Once ready for testing, the frozen ballast layer sample 214 is placed between a base 210 and a cover 212 and wrapped in one or more membranes 216 such that the frozen ballast layer sample 214 is ready for triaxial testing using the triaxial testing frame 300. The frozen ballast layer sample 214 is then placed inside a chamber 302 surrounded by rods 304 to create a sealed sample 218. An actuator 306 coupled to a pneumatic controller 308 is then activated via the triaxial testing frame 300 to carry out the permanent deformation tests described in the Examples section below.

Referring more specifically to the freezing system 200, it is to be understood that the ballast layer sample 100 is first placed in the cylindrical mold 202. Further, a compaction machine 200 (e.g., a vibratory compaction machine), can be used to compact the ballast layer sample 100, which is dry at this point. The resulting compacted ballast layer sample 100 can have a void ratio ranging from about 0.55 to about 0.75, such as from about 0.58 to about 0.72, such as about 0.60 to about 0.70. In one particular embodiment, the compacted ballast layer sample 100 can have a void ratio of about 0.65.

Once the ballast layer sample 100 is compacted, the cylindrical mold 202 can be wrapped in at least one membrane 216 that can be formed of rubber. For instance, in some embodiments, two membranes 216 can be used. In other instances, three membranes 216 can be used. Regardless of the number of membranes 216 used, the membranes 216 can each have a thickness ranging from about 0.65 millimeters to about 0.85 millimeters, such as from about 0.70 millimeters to about 0.80 millimeters, such as from about 0.72 millimeters to about 0.78 millimeters. In addition, the membranes 216 can each have a tensile strength ranging from about 20 megapascals to about 35 megapascals, such as from about 22.5 megapascals to about 32.5 megapascals, such as from about 25 megapascals to about 30 megapascals.

Thereafter, the compacted ballast layer sample 100 can be saturated with water 203, and the cooling blanket 204 can be wrapped around the cylindrical mold 202 and filed with a thermal transfer fluid 222. The thermal transfer fluid 222 can have a freezing point of less than about −20° C., such as less than about −22.5° C., such as less than about −25° C. For instance, the thermal transfer fluid 222 can include a mixture of ethylene glycol and water. Further, the ethylene glycol can be present in the thermal transfer fluid 222 in an amount ranging from about 25 wt. % to about 75 wt. %, such as from about 30 wt. % to about 70 wt. %, such as from about 40 wt. % to about 60 wt. %, and the water can be present in the thermal transfer fluid 222 in an amount ranging from about 25 wt. % to about 75 wt. %, such as from about 30 wt. % to about 70 wt. %, such as from about 40 wt. % to about 60 wt. %. In some embodiments, the ethylene glycol can be present in an amount of about 50 wt. % and the water can be present in an amount of about 50 wt. %.

A tube 220 can be used to connect the chiller unit 208 to the cooling blanket 204, where the thermal transfer fluid 222 is thus circulated in a loop from the chiller unit 208 to the cooling blanket 204 to create a flow cycle to decrease the temperature of the cooling blanket to a temperature ranging from about −10° C. to about −20° C., such as from about −12° C. to about −18° C., such as from about −14° C. to about −16° C. Moreover, at least one layer, such as two layers, three layers, four layers, or additional layers, of the thermal isolation material 206 can be wrapped around the cooling blanket 204 to create a sealed space that reduces thermal dissipation to efficiently freeze the compacted ballast layer sample 100 to form the frozen ballast layer sample 214. This freezing system 200 can be used to create frozen ballast layer samples 214 that can be tested to determine the effect of progressive thawing on new and degraded railroad ballast layer samples or aggregates.

As discussed below, the experimental results show that ballast layer samples or aggregates subjected to progressive thawing conditions exhibit a deformation pattern associated with pore ice contents. New and degraded ballast aggregates are characterized by distinct deformation behaviors under progressive thawing conditions, where such conditions are modeled using the aforementioned freezing system 200.

The present disclosure is further described in the following Examples, which do not limit the scope of the disclosure described in the claims.

### Example 1

### Ballast Material

Ballasted track is constructed with coarse aggregates following specified particle size requirements, and different countries have proposed various gradation requirements for their railroad tracks. For example, the American Railway Engineering and Maintenance-of-Way Association (AREMA) implements four gradation curves (AREMA No. 3, No. 4, No. 24, and No. 25) for main railway lines in the United States. The particle size distribution of the ballast material used in this study (shown by the solid line in FIG. 3) strictly follows the requirements of AREMA No. 3 (represented by the two dotted lines in FIG. 3). The minimum diameter of ballast particles is 12.7 mm (0.5 in.) and the maximum diameter is 50 mm (2 in.). Note that the new ballast used in the described laboratory tests is sourced from the U.S. Class I railroad revenue track provided by BNSF Railway, while degraded ballast samples in this study are prepared with used ballast that has already undergone a series of large-scale triaxial cyclic and monotonic tests.

### Freezing System and Sample Preparation

To prepare frozen samples suitable for large-scale triaxial testing, a new freezing system 100 was developed based on an existing compaction platform. As shown in FIG. 4A, dry ballast material is first compacted in a cylindrical mold 202 using a vibratory compaction machine, resulting in a compacted ballast layer sample 100 with a void ratio of 0.65. The mold 202 containing the compacted ballast material is wrapped in two layers of membranes 216, each with a thickness of 0.76 mm and a tensile strength of 27.6 MPa, where the membranes are rubber. Then, after saturating the compacted sample with water, a cooling blanket 204 filled with thermal transfer fluid (not shown) is attached to the compaction cylindrical mold 202 (shown in FIG. 4B). The fluid is a mixture of 50% ethylene glycol and 50% water, with a freezing point lower than −25° C., allowing flow cycling even in freezing conditions. Following that, multiple layers of thermal insulation materials 206 are wrapped around the cooling blanket 204 to create a sealed space that reduces thermal dissipation, as seen in FIG. 4C. Finally, a chiller unit 208 is connected to the cooling blanket 204 through a plastic tube 222 to form a flowing cycle, as shown in FIG. 4D. The chiller unit 208 used in this study can decrease the temperature of the thermal transfer liquid to a preset low temperature and then pump the low temperature fluid into the cooling blanket 204. The fluid passing through the cooling blanket 204 flows back to the chiller unit 208, forming a thermal transfer cycle. Saturated ballast layer samples 100 are cooled by the low-temperature liquid in the cooling blanket 204 according to predetermined conditions, resulting in a frozen ballast layer sample 214 after a time period of 48 hours. The temperature inside the thermal insulation material 206 is measured to be −15° C.

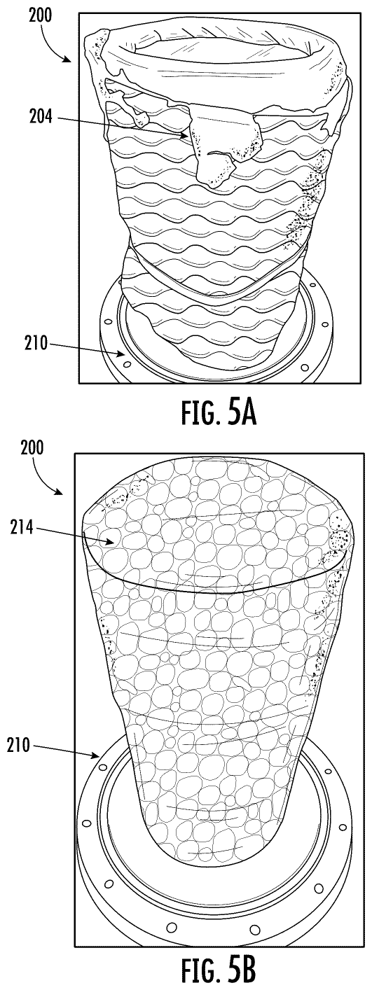

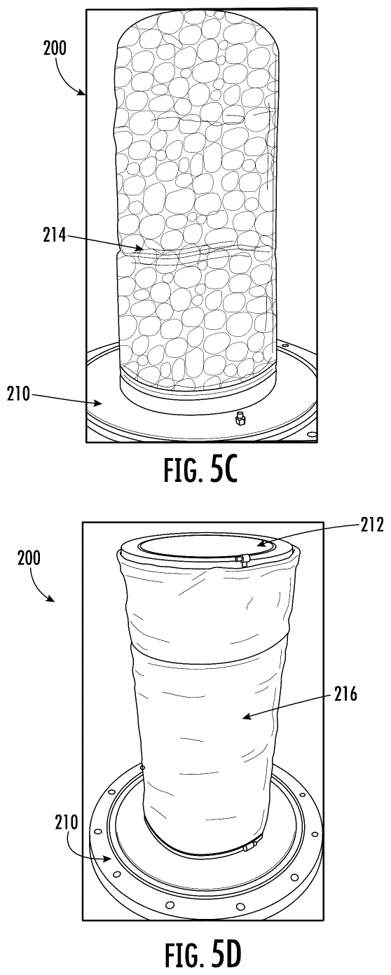

FIG. 5A shows the freezing phenomenon near the cooling blanket 204 after detaching the thermal insulation materials 206. When the cooling blanket 204, cylindrical mold 202, and membranes 216 are removed, a fully frozen ballast layer sample 214 is clearly seen in FIGS. 5B and 5C. Note that all ballast particles are strongly bonded with ice at a temperature of −15° C. Unlike previous studies on the uniaxial compression strength of frozen ballast, this research aims to investigate the permanent deformation of frozen ballast under coupled cyclic loading and progressive thawing conditions. Therefore, frozen ballast layer samples 214 are wrapped with three layers of membranes 216 (with a total thickness of 2.28 mm) for applying confining pressure during cyclic triaxial testing, as shown in FIG. 5D. The prepared frozen ballast sample 214 has typical dimensions for large-scale triaxial tests, with a diameter of 300 mm (about 12 inches) and a height of 600 mm (about 24 inches).

### Triaxial Testing Frame

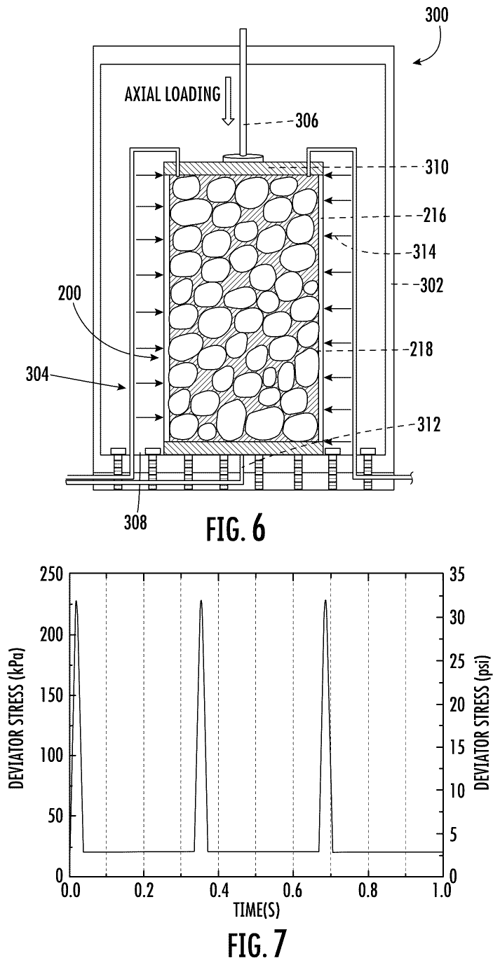

A series of large-scale triaxial cyclic and monotonic tests were performed using an advanced loading frame or triaxial testing frame 300. This setup can accommodate different ballast samples, including dry, wet, and frozen. This study involves triaxial tests on dry samples and frozen samples under progressive thawing conditions. As shown in FIG. 6, the triaxial testing frame 300 can achieve a maximum axial force of 250 kN, and the actuator 306 is capable of moving with a maximum displacement of 100 mm (3.94 inches), equivalent to 16.6% axial strain for samples with a 24 inch height. The compacted sample is placed inside the triaxial testing frame 300's chamber 302, which is then locked onto the base pedestal with bolts or rods 304 to create a well-sealed space for applying confining pressure to the sealed sample 218. Once the target confining pressure is set, the pneumatic controller 308 pumps compressed air into the sealed triaxial chamber 302. The compressed air pressure, or confining pressure 314, is exerted on the membrane 216 to mimic the lateral confinement in a ballasted track. When the confining pressure inside the chamber 302 stabilizes, the actuator 306 moves to seat on a loading plate 310 for applying axial loads. Cyclic tests are performed under both dry and progressive thawing conditions on two types of ballast materials to compare their deformation behaviors. Drainage valves 312 provide for release of any water due to thawing or melting of the any frozen ballast samples 218 For the monotonic tests, the shear strength of new and degraded ballast aggregates under dry conditions is evaluated to interpret the observed permanent deformation behavior under the dry testing scenario.

### Cyclic Loading Design

This testing setup supports customized cyclic loading pulses, allowing the application of different loading waveforms on tested samples. As shown in FIG. 7, a loading pulse with a rest time accounting for 90% of each cycle is applied in this study to consider the interval between two consecutive bogies of railway cars, as observed in the railroad field. The loading frequency of cyclic tests in this study is 3 Hz, equivalent to a train speed of about 55 km/h. Therefore, each loading cycle is allocated 0.333 seconds, with a rest time of 0.3 seconds per cycle. The deviator stress on the y-axis in FIG. 7 represents the axial stress subtracted by the confining pressure. According to field observations, the measured horizontal stress of ballast beneath the sleeper is within 10 psi. Therefore, a confining pressure of 69 kPa (10 psi) is used in this study to simulate the lateral confinement level of the ballast layer in the field. The same confinement level is also found in reported studies on triaxial testing of ballast mechanical behaviors. The repeated train loading is mimicked by a maximum deviator stress of 220 kPa (31.9 psi), and the effect of rail and sleeper weight is simulated by a minimum deviator stress of 20 kPa (2.9 psi).

### Progressive Thawing Condition

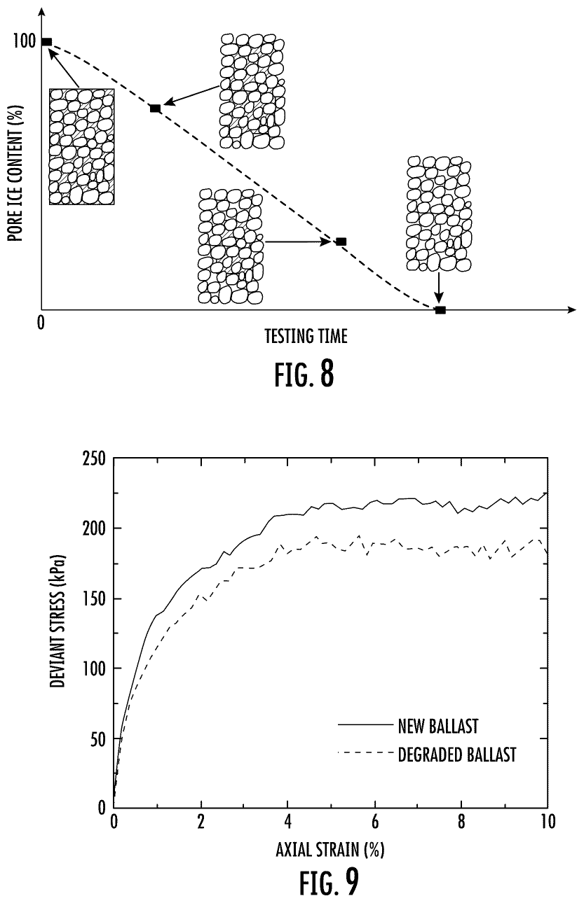

This study involves testing the permanent deformation of frozen ballast under cyclic loading and progressive thawing conditions, revealing the role of global warming and seasonal effects on the performance of railroad infrastructure in cold regions. Laboratory tests are performed at a room temperature of about 18° C., imposing a temperature gradient on the frozen sample to cause progressive ice thawing. Note that the drainage valves are left open during cyclic loading, allowing thawed water to flow out of the tested sample from the bottom drainage valves. This aligns with the characteristic high drainage performance and low water retention capacity of ballast aggregates. At the same time, the cyclic loading waveform shown in FIG. 7 is applied to the frozen ballast, which is confined with a pressure of 10 psi. Thus, there is a coupled effect of cyclic loading and progressive thawing conditions exerted on the ballast samples. At the beginning of cyclic testing, the frozen sample is fully bonded with ice, and the pore ice content (defined as ice volume divided by total pore volume) is 100%, as shown in FIG. 8. As the pore ice content decreases, ice bonds on the outer parts of the frozen sample disappear first, then the ice thawing boundary gradually moves inward, and ice in the sample core begins to melt. This process is reflected in the rubber membrane penetration observed during laboratory testing. The disappearance of ice bonds results in more discrete ballast particles, and this progressive alteration of fewer ice bonds and more discrete aggregates influences deformation behaviors even under the same cyclic loading. At the end of ice thawing, the tested sample is filled with discrete particles, and no more ice bonds exist inside the sample.

### Results

### Effect of Ballast Degradation on Shear Strength Under Dry Conditions

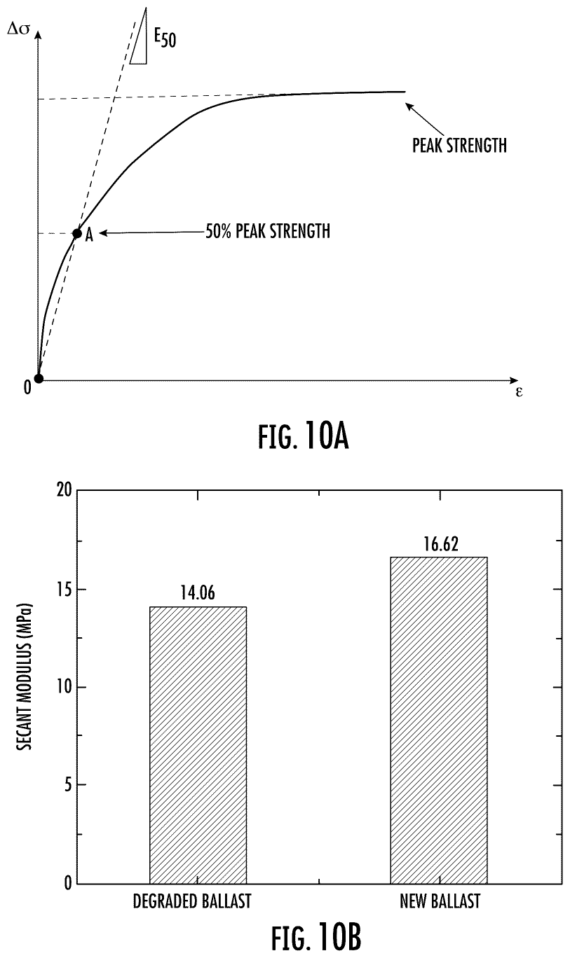

New and degraded ballast aggregates are tested under monotonic loading to evaluate their shear strength under dry conditions, providing evidence to interpret their deformation behavior presented in the later section. Moreover, particle morphology of new and degraded ballast aggregates is not quantitatively quantified in this study, and investigating their shear strength could help readers qualitatively understand the role of particle shapes on mechanical behaviors. The loading rate in monotonic shear tests is 1% axial strain per minute (equivalent to 0.1 mm per second) under a strain-controlled loading pattern. The same loading rate used for triaxial testing on ballast aggregates can be found in the literature. The monotonic shear tests are stopped at an axial strain of 10%, as the observed shear strength has remained constant, as shown in FIG. 9. New ballast aggregate has a maximum shear strength of 224 kPa, while degraded ballast shows a maximum shear strength of 194 kPa. The lower shear strength of degraded ballast compared to new ballast is attributed to its reduced friction angle, and similar results can be found in previous publications. FIG. 9 shows that under the same deviator stress, new ballast produces a lower axial strain compared to degraded ballast, indicating a different deformation magnitude. Similarly, under the same axial strain, new ballast exhibits higher deviator stress than degraded ballast. In other words, the deformation of ballast samples under cyclic loading is related to their modulus. As shown in FIG. 10A, the secant modulus (E50) is analyzed in this study, and new ballast exhibits a higher E50 compared to degraded ballast, as shown in FIG. 10B.

### Effect of Ballast Degradation on Permanent Deformation Under Dry Conditions

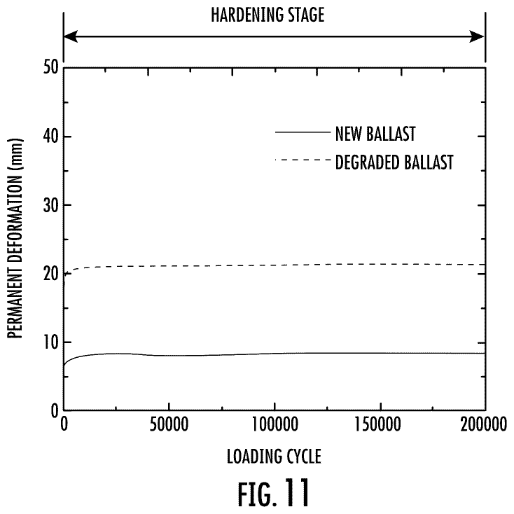

Permanent deformation of new and degraded ballast aggregates under dry testing conditions is presented in FIG. 11. The dry condition refers to the compacted dry ballast being directly tested in the large-scale triaxial loading frame without experiencing freezing. These results are reserved for comparison with the deformation behavior of ballast under progressive thawing conditions in the later section. At the beginning of cyclic loading, the deformation of both new and degraded ballast develops quickly within a few cycles and tends to stabilize under subsequent loading cycles, exhibiting a clear shakedown behavior. After 200,000 loading cycles, the new ballast sample generates a permanent deformation of 8.58 mm, while degraded ballast shows a higher deformation of 21.46 mm. The different deformation magnitudes between degraded and new ballast can be attributed to the modulus variation observed in FIG. 11, and existing research supports this result.

### Permanent Deformation Characteristics Under Progressing Thawing Conditions

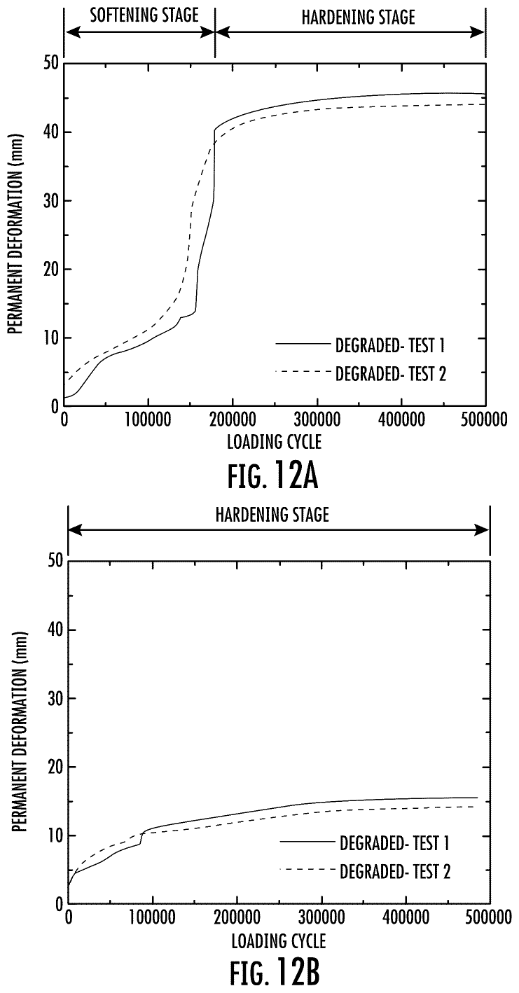

FIG. 12A shows the permanent deformation of frozen degraded ballast under cyclic loading and progressive thawing conditions. To verify the repeatability of the obtained results, two frozen degraded samples are tested under the same conditions. It can be observed that their permanent deformation develops quickly within about 175,000 loading cycles, exhibiting a softening behavior. After that, the permanent deformation gradually stabilizes under the subsequent loading cycles, presenting a hardening behavior. Therefore, the permanent deformation of frozen degraded ballast under cyclic loading and progressive thawing conditions is characterized by two stages: a softening stage and a hardening stage. The observed softening stage is attributed to the gradually reduced pore ice content, which causes the strength of ice-bonded ballast aggregates to decrease continuously. Compared with the results obtained from dry scenarios, it is reasonable to consider the softening stage as another type of shakedown behavior, because the permanent deformation becomes stable in the subsequent hardening stage. In contrast, frozen new ballast samples under cyclic loading and progressive thawing conditions exhibit a consistent hardening stage (seen in FIG. 12B), which is different from the observed deformation behaviors of frozen degraded ballast. Moreover, under the same loading cycles, frozen degraded ballast samples have an average permanent deformation of 44.81 mm, while frozen new ballast samples have a much lower average permanent deformation of 14.67 mm.

### Relationship Between Permanent Deformation and Pore Ice Content

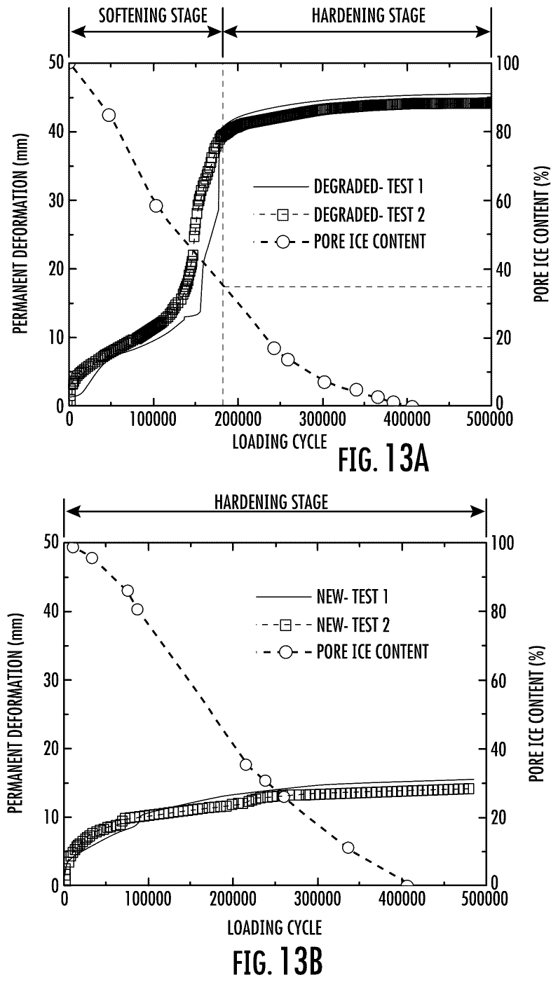

To explore the relationship between permanent deformation and pore ice content, the amount of thawed water obtained from the bottom drainage valves is also measured in a timely manner during cyclic loading. Therefore, the pore ice content remaining inside the tested samples can be determined by subtracting the recorded thawed water from 100%. The correlation between pore ice content and permanent deformation is presented in FIGS. 13A and 13B. Both new and frozen degraded samples are found to be completely thawed after 400,000 loading cycles, and the pore ice content keeps decreasing with additional loading cycles. In FIG. 13A, the observed softening stage of frozen degraded ballast occurs as the pore ice content decreases from 100% to 35%, and the sample exhibits a hardening behavior once the remaining pore ice content is at 35%. This observation indicates that, for railroad tracks with degraded ballast built on permafrost and in seasonally frozen regions, permanent deformation would significantly increase until the pore ice content decreases to 35%. If the pore ice content goes beyond 35%, the deformation rate would stabilize with a much lower deformation rate. Note that the observed turning point (35% pore ice content) for permanent deformation of frozen degraded ballast could be dependent on the particle size distribution of ballast and the aggregate degradation levels, which deserves more investigation for wide guidance of railroad maintenance. For the frozen new ballast, the permanent deformation rate always decreases even as the pore ice content is gradually reduced, as shown in FIG. 13B. This means that newly constructed ballasted tracks in cold regions would have lower permanent deformation, even with the effect of ice thawing. These findings could provide guidance for scheduling railroad track maintenance in permafrost and seasonally frozen regions.

### Effect of Progressive Thawing Conditions on Permanent Deformation

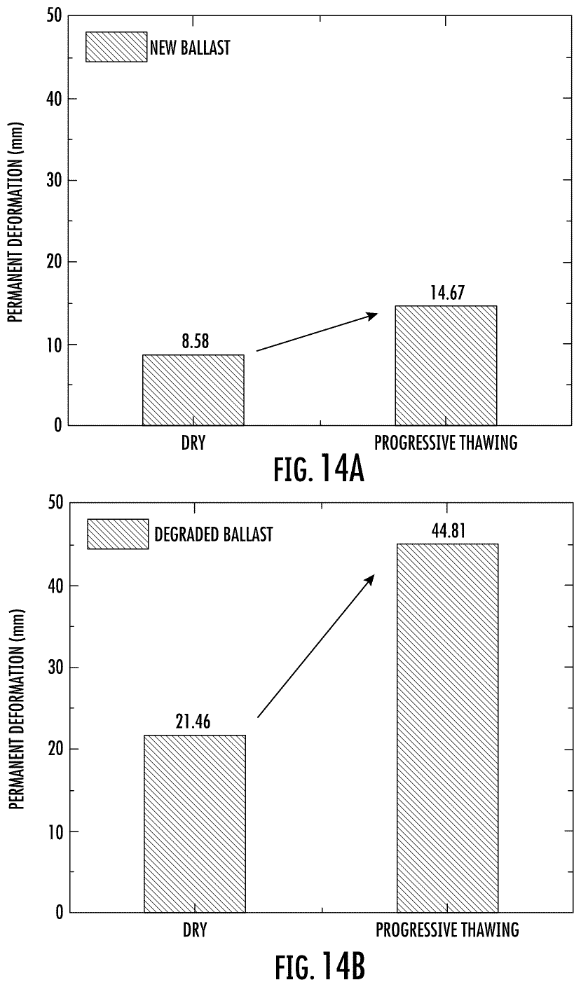

To compare the effects of progressive thawing and dry conditions on new and degraded ballast aggregates, the measured magnitudes of permanent deformation at the end of cyclic loading tests are plotted together. As shown in FIG. 14A, new ballast under dry conditions has a permanent deformation of 8.58 mm, while the progressive thawing condition increases its deformation to 14.67 mm. As shown in FIG. 14B, for degraded ballast, the dry condition produces a deformation magnitude of 21.46 mm, and a permanent deformation of 44.81 mm is observed under progressive thawing conditions. In terms of the deformation difference between dry and progressive thawing conditions, new ballast shows a difference of 6.09 mm, compared to 23.35 mm for degraded ballast. Interestingly, although the frozen ballast is bonded with ice, their deformation under progressive thawing conditions is still larger than under dry conditions. This phenomenon is attributed to the lubrication effect of ice debris remaining inside after ice bond breakage and the ice film on the aggregate surface. Additionally, the deformation difference between dry and progressive thawing conditions is dependent on the ballast material, with progressive thawing showing a more significant effect on the permanent deformation of degraded ballast. This result indicates that the permanent deformation of degraded ballast is more sensitive to the progressive thawing effect.

### CONCLUSIONS

This research investigates the permanent deformation of frozen new and degraded ballast under cyclic loading and progressive thawing conditions. The frozen sample is prepared using the freezing system described by the present disclosure, with typical dimensions suitable for large-scale triaxial tests.

A freezing system was developed to shape frozen samples with typical ballast triaxial test sample dimensions. To provide in-depth insights into the mechanical behavior of ice-bonded ballast, the frozen samples were tested under cyclic loading coupled with progressive thawing conditions and compared with samples tested under both dry and thawed conditions. Based on the results obtained, the key conclusions are as follows: under the same confining pressure and number of loading cycles, frozen ballast accumulates the largest permanent deformation under progressive thawing conditions. This behavior is attributed to the lubricating effects of ice lenses within ballast voids, as well as the presence of ice and water films on the ballast surface. The permanent deformation rates of ice-bonded ballast under cyclic loading, coupled with progressive thawing conditions, exhibit a consistent correlation with the decreasing rate of ice content, indicating that the permanent deformation of ice-bonded ballast is primarily governed by its ice content. Furthermore, compared to the dry condition, the thawed samples show greater permanent deformation due to the presence of retained moisture on the aggregate surface.

The key findings from this study can be summarized as follows:
1. Although the frozen ballast sample is bonded with ice, its permanent deformation under progressive thawing conditions is higher compared to the dry testing condition due to the lubrication effect after ice bond breakage.
2. The permanent deformation of frozen degraded ballast under progressive thawing conditions can be characterized into two stages: a softening stage and a hardening stage, while frozen new ballast only exhibits a hardening stage.
3. Pore ice contents inside the frozen ballast sample are associated with their deformation behavior under progressive thawing conditions. A pore ice content of 35% is found to be a turning point for the frozen degraded ballast sample to enter the hardening stage, while frozen new ballast always shows a hardening stage with decreasing pore ice content.
4. The effect of progressive thawing conditions on the permanent deformation of frozen ballast is dependent on the level of aggregate degradation. Frozen degraded ballast is more sensitive to progressive thawing conditions compared to frozen new ballast.

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the present disclosure, but instead as merely intended to highlight alternative or additional features that may or may not be utilized in a particular embodiment of the present disclosure. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments. For instance, when a plurality of ranges are provided, any combination of a minimum value and a maximum value described in the plurality of ranges are contemplated by the present disclosure. For example, if ranges of ‘from about 20% to about 80%’ and ‘from about 30% to about 70%’ are described, a range of ‘from about 20% to about 70%’ or a range of ‘from about 30% to about 80%’ are also contemplated by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article ‘a’ or ‘an’ does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ‘at least one’ and ‘one or more’ to introduce claim recitations. However, the use of such phrases should not be construed to imply that the introduction of a claim recitation by the indefinite articles ‘a’ or ‘an’ limits any particular claim containing such introduced claim recitation to embodiments containing only one such recitation, even when the same claim includes the introductory phrases ‘one or more” or ‘at least one’ and indefinite articles such as ‘a’ or ‘an’ (e.g., ‘a’ and/or ‘an’ should typically be interpreted to mean ‘at least one’ or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of ‘two recitations,’ without other modifiers, typically means at least two recitations, or two or more recitations). Furthermore, in those instances where a convention analogous to ‘at least one of A, B, and C, etc.’ is used, in general such a construction is intended in the sense one having skill in the art would understand the convention (e.g., ‘a system having at least one of A, B, and C’ would include but not be limited to systems that have A alone, B alone, C alone, A and B together, A and C together, B and C together, and/or A, B, and C together, etc.). In those instances where a convention analogous to ‘at least one of A, B, or C, etc.’ is used, in general such a construction is intended in the sense one having skill in the art would understand the convention (e.g., ‘a system having at least one of A, B, or C’ would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase ‘A or B’ will be understood to include the possibilities of ‘A’ or ‘B’ or ‘A and B.’

All numbers expressing quantities of ingredients, reaction conditions, and so forth used in the specification are to be understood as being modified in all instances by the terms ‘about,’ ‘approximately,’ or ‘generally.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches. As used herein, the terms ‘about,’ ‘approximately,’ or ‘generally,’ when used to modify a value, indicate that the value can be raised or lowered by 5% and remain within the disclosed embodiment.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A freezing system for preparing a frozen ballast layer sample, the freezing system comprising:
a cylindrical mold;
a cooling blanket;
at least one layer of a thermal isolation material; and
a chiller unit, wherein the freezing system is configured to freeze a compacted ballast layer sample to a temperature ranging from about −10° C. to about −20° C.

2. The freezing system of claim 1, further comprising a compaction machine, wherein the compaction machine is configured to compact the compacted ballast layer sample to a void ratio ranging from about 0.55 to about 0.75.

3. The freezing system of claim 1, further comprising at least one membrane wrapped around the cylindrical mold, wherein the at least one membrane has a thickness ranging from about 0.65 millimeters to about 0.85 millimeters and a tensile strength ranging from about 20 megapascals to about 35 megapascals.

4. The freezing system of claim 3, wherein the at least one membrane comprises rubber.

5. The freezing system of claim 3, wherein the at least one membrane comprises two membranes.

6. The freezing system of claim 1, further comprising water, wherein the compacted ballast layer sample is saturated with water prior to freezing.

7. The freezing system of claim 1, wherein the cooling blanket is filled with a thermal transfer fluid having a freezing point of less than about −20° C.

8. The freezing system of claim 7, wherein the thermal transfer fluid comprises a mixture of ethylene glycol and water.

9. The freezing system of claim 7, wherein the chiller unit is connected to the cooling blanket via a tube.

10. The freezing system of claim 9, wherein the thermal transfer fluid is circulated through the cooling blanket via the chiller unit to create a flow cycle to decrease the temperature of the cooling blanket to a temperature ranging from about −10° C. to about −20° C.

11. The freezing system of claim 1, wherein the at least one layer of the thermal isolation material is wrapped around the cooling blanket.

12. A method for preparing frozen ballast samples using a freezing system comprising a cylindrical mold, a cooling blanket, at least one layer of a thermal isolation material, and a chiller unit, the method comprising:
obtaining a ballast layer sample;
depositing the ballast layer sample into the cylindrical mold;
saturating the ballast layer sample with water;
attaching the cooling blanket to the cylindrical mold;
wrapping the cooling blanket with the at least one layer of the thermal isolation material; and
activating the chiller unit to circulate a thermal transfer fluid throughout the cooling blanket, wherein the ballast layer sample is frozen to a temperature ranging from about −10° C. to about −20° C.

13. The method of claim 12, further comprising compacting the ballast layer sample a compaction machine to a void ratio ranging from about 0.55 to about 0.75 prior to saturating the ballast layer sample with water to form a compacted ballast layer sample.

14. The method of claim 13, the method further comprising wrapping the cylindrical mold in at least one membrane, wherein the at least one membrane has a thickness ranging from about 0.65 millimeters to about 0.85 millimeters and a tensile strength ranging from about 20 megapascals to about 35 megapascals.

15. The method of claim 14, wherein the at least one membrane comprises rubber.

16. The method of claim 14, wherein the at least one membrane comprises two membranes.

17. The method of claim 12, wherein the thermal transfer fluid has a freezing point of less than about −20° C.

18. The method of claim 12, wherein the thermal transfer fluid comprises a mixture of ethylene glycol and water.

19. The method of claim 12, wherein the chiller unit is connected to the cooling blanket via a tube.

20. The method of claim 12, wherein the thermal transfer fluid is circulated through the cooling blanket via the chiller unit for a time period ranging from about 12 hours to about 60 hours.
